(19) United States
(12) Patent Application Publication
(10) Pub. No.: US 2016/0047741 A1
(43) Pub. Date: Feb. 18, 2016

(54) METHOD AND APPARATUS FOR MONITORING AND CONTROLLING A CLEANING PROCESS

(71) Applicant: Kyzen Corporation, Nashville, TN (US)

(72) Inventors: David T. Lober, Franklin, TN (US); Haley Nicole Jones, Hendersonville, TN (US); Jonathon Afugu, Antioch, TN (US); Kyle J. Doyel, Franklin, TN (US); Ram Wissel, Franklin, TN (US); Michael L. Bixenman, Old Hickory, TN (US)

(21) Appl. No.: 14/501,552

(22) Filed: Sep. 30, 2014

Related U.S. Application Data
(60) Provisional application No. 62/038,649, filed on Aug. 18, 2014.

(51) Int. Cl. G01N 21/3577; G05D 11/13

(52) U.S. Cl. CPC G01N 21/3577; G05D 11/13; G01N 2201/12

(57) ABSTRACT

A method of accurately measuring the concentration of at least one of an aqueous cleaning agent and soil in an aqueous cleaning process which includes providing a source of near infrared light emitting useful amounts of light with wavelengths between approximately 0.8 μm and 2.5 μm, transmitting the near infrared light from the light source to a probe, contacting the probe with a cleaning bath sample such that one of the absorption and the reflection of the light at one or more wavelengths can be measured, transmitting the light that has interacted with the sample to a detector, measuring the change in light intensity at one or more wavelengths in the near infrared region using a near infrared detector, generating an electronic signal that is representative of the change in intensity, applying chemometric techniques to quantitatively determine the concentration of the cleaning agent and or soil, and outputting the measured cleaning agent or soil concentration. The light source is connected to the probe via a fiber-optic cable and the probe is connected to the detector via a fiber-optic cable.

### CROSS-REFERENCE TO RELATED APPLICATION

This application claims the benefit of Provisional Application Ser. No. 62/038,649, filed Aug. 18, 2014, entitled Method for Monitoring and Controlling a Cleaning Process, which is embodied herein in its entirety.

### BACKGROUND

In the manufacturing processes for many products, there are oils, greases, soils, fluxes, and other contaminates that are either deliberately added for ease of manufacture, or are introduced undesirably to the part. Many manufactured products will require these contaminates to be removed before certain steps or after completion of the product. Failure to completely remove these contaminates from products can lead to a wide range of failures, from being aesthetically unpleasing, to a catastrophic product failure that may result in the loss of life.

### BRIEF SUMMARY

The instant method is based on using near infrared spectroscopy (NIRS) in a cleaning process to allow accurate measurements to be made of the cleaning agent concentration and/or soil in a bath for cleaning soils or contaminates from the products. This ensures the effectiveness of the cleaning process and lowers the cost of the process. The invention also includes the apparatus, or system, for carrying out the method.

### BRIEF DESCRIPTION OF THE DRAWINGS

FIG. 1 is a graph of a calibration model for virgin cleaner at ambient conditions;

FIG. 2 is a graph of calibration model with flux;

FIG. 3 is a chart showing a comparison of three methods to a reference method;

FIG. 4 is a chart showing a comparison of three methods with a reference method;

FIG. 5 is a chart showing sample distribution;

FIG. 6 is a chart showing equal variances for refractive index;

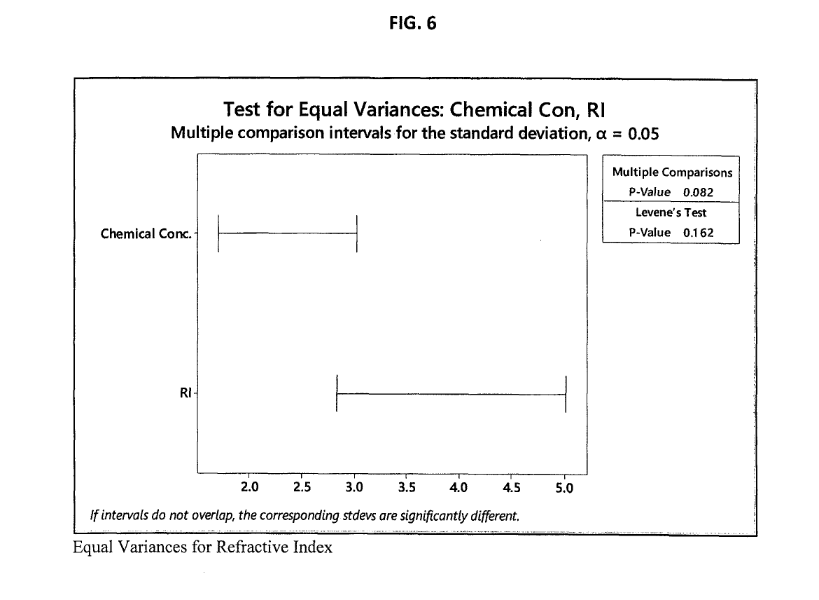

FIG. 7 is a chart showing equal variances for sonic velocity;

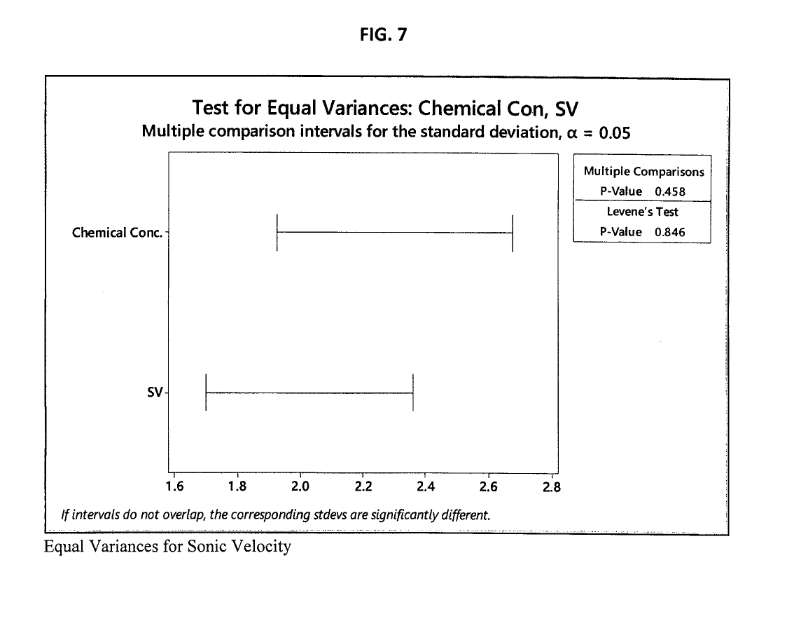

FIG. 8 is a chart showing equal variances for differential density;

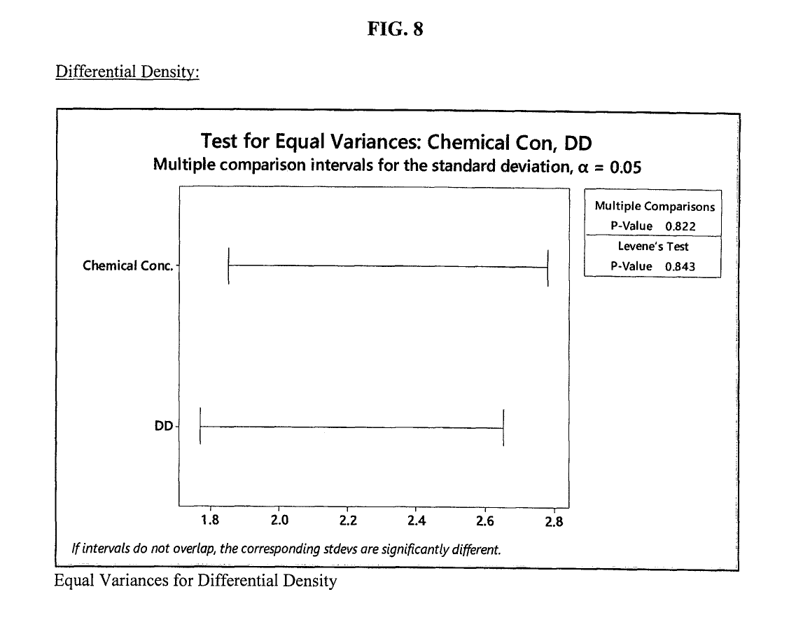

FIG. 9 is a chart showing equal variances forth instant method;

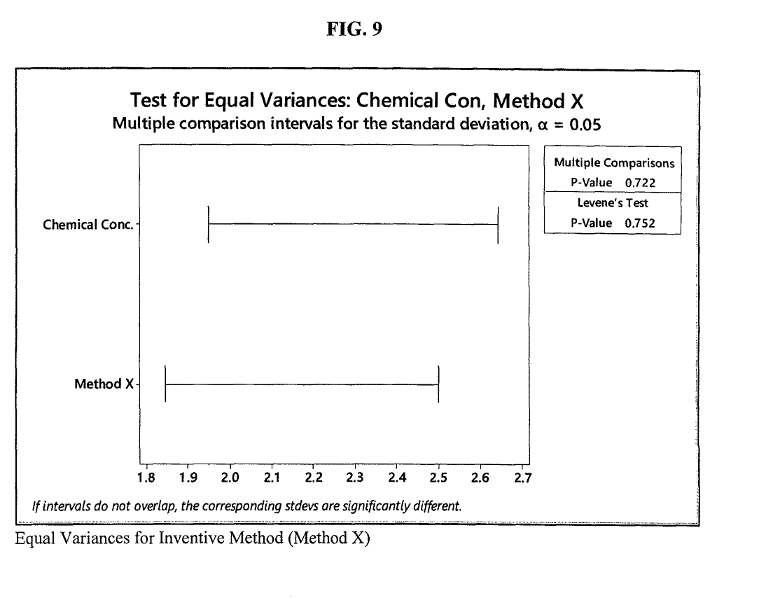

FIG. 10 is a chart showing equal variances for all the tested methods;

FIG. 11 is a chart showing means of ranks from the Tukey test;

FIG. 12 is a chart with interval plots of reading differences;

FIG. 13 is a chart with a comparison of interval and median for virgin and flux loaded samples at 95% Cl;

FIG. 14 is a chart of bath cycles over multiple years

FIG. 15 is a chart showing conductivity of flux loaded samples;

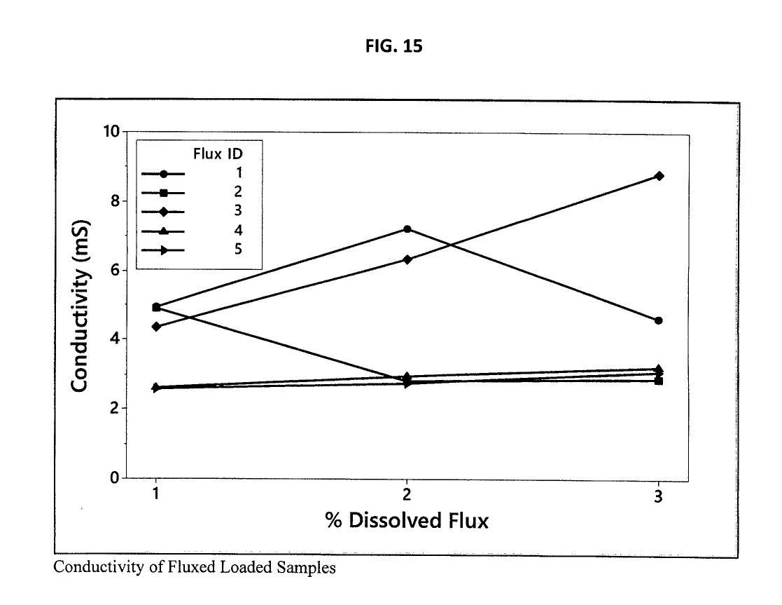

FIG. 16 is a chart showing recent concentration data; and

FIG. 17 is a chart showing chemical and water usage trends.

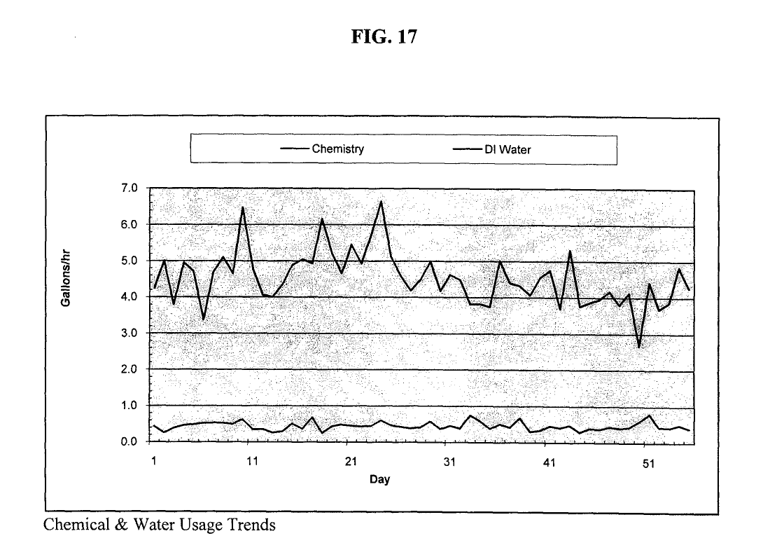

### DETAILED DESCRIPTION OF EMBODIMENTS

An aqueous cleaning process is one where a cleaning agent is mixed with water (i.e. diluted) to a desired concentration. The factors and methods used to determine the optimum concentration or concentration range of the cleaning agent are known to those skilled in the art. If there are deviations from the optimum concentration there can be severe costs, and ramifications to the manufacturer of the parts and end users. There can be damage to the parts or there can be unacceptable product life spans. An example of a reduction in product lifespan due to improper cleaning is the removal of solder flux from a high reliability printed circuit board (PCB), which is used in an application where failure of the PCB risks a loss of life incident or failures resulting in large financial losses. This is an area where this invention is to be applied. The solder flux is corrosive and can cause shortening of the PCB's lifetime and reliability, yet solder flux must be used in that assembly process. This demands that the solder flux must be removed for the reliability and lifespan of the product. If the concentration of cleaning agent is too low or high there is a risk of not adequately removing the contamination from the part, yielding a product that is incompletely cleaned. At best, this may lead to a costly and embarrassing product recall or at worse there may be actual loss of life incidences. If the concentration of the cleaning agent is too high, in addition to incomplete cleaning the increased concentration adds cost to the process, and can also cause damage to solder joints, part markings, or components, which may cause premature failure of the parts. Another reason that the concentration of the cleaning agent might need to be measured is to meet certain regulations or requirements, usually related to documenting that the manufacturing process is stable over time with respect to the reliability of the parts. This requirement, which may be internal to the manufacture, contractually specified by the manufacturer's customer, or by regulations.

There are a wide variety of aqueous cleaning processes all designed to meet certain needs and constraints of each process. There are different variations in how the parts are supplied to the cleaning equipment and move through the cleaning process such as batch processes, in which parts are loaded into a cleaner which runs a program that controls the process parameter and inline processes where the parts are fed into the machine on a conveyer belt which takes them through the machine. Then there are different methods for contacting the cleaning agent with the parts being cleaned. Some examples of contacting methods are spray-in-air methods in which the cleaning agent is sprayed onto the parts, and spray-under-immersion processes where the part is immersed in the cleaning agent. There are many other implementation of aqueous cleaning methods, one utility of the invention is its applicability to all cleaning processes in which the cleaning agent is used to clean multiple parts. Regardless of the exact cleaning process, over time the concentration of cleaning agent will change.

The cleaning solution is typically supplied as a concentrate, and usually is a blend of many different raw materials, each designed to give a desired property to the diluted cleaning agent. In some circumstances the cleaning agent is already supplied at the desired concentration, i.e., sold as the diluted solution, but this is an exception to the rule. Representative U.S. patents in which typical cleaning agents are taught are Doyel et al. U.S. Pat. No. 6,699,829 B2, Bixenman et al. U.S. Pat. No. 5,128,057, Doyel et al. U.S. Pat. No. 7,288,511 B2, and Doyel et al. U.S. Patent Publication No. 2012/0152286, all of which are embodied herein in their entireties by reference. The exact composition of concentrated cleaning agents often is proprietary so the discussion herein is very brief but will be well known to those who manufacture cleaning agents. Typically the concentrated cleaning solution contains one or more solvents, which help dissolve organic materials. One of the main classes of solvents used is propylene based glycol ethers which have good solubilizing properties as well as favorable health and safety profiles, but other solvents, such as alcohols may be used as well. In addition to solvents there typically are amines, which serve to remove acids, such as flux, and serve to increase the pH. If the cleaning agent concentration is low there may not be enough of the amine to effectively remove the flux. However, if the concentration of the cleaning agent is too high, the amine content in the bath or pH may be too high and cause corrosion or other forms of damage to the parts being cleaned and/or the cleaning equipment. This underscores the need to control the concentration of some formulations of cleaning agents, as the increase in reliability brought about by cleaning would be negated by the damage to the part. To counter this effect many cleaning agents use the amines as part of a buffer system, along with acids in the concentrated cleaning solution, to maintain a constant pH of the cleaning solution. This adds considerable benefit, as it eliminates changes in pH which could damage parts, especially since soils are typically acidic or basic. However, because the pH is relatively constant for cleaning agents which are buffered, pH cannot be used to measure the cleaning agent concentration or the soil concentration. Additionally there are usually one or more corrosion inhibitors to aid in protecting the cleaning equipment and any metal on the parts being cleaned. Surfactants are another main class of materials in the concentrated cleaning agent. If the concentration of the cleaning agent is too high or too low, the surfactants may precipitate out and lose their effectiveness or may cause the bath to develop foam, both of which are not desirable. As illustrated above the cleaning agent concentration needs to be kept constant.

Often, the composition containing the cleaning agent comprises more than one liquid phase. The two phases are an aqueous phase and a solvent rich phase. The solvents could be propylene oxide based glycol ethers: propylene glycol methyl ether, dipropylene glycol methyl ether, tripropylene glycol methyl ether, propylene glycol methyl ether acetate, dipropylene glycol methyl ether acetate, propylene glycol n-propyl ether, dipropylene glycol n-propyl ether, propylene glycol n-butyl ether, dipropylene glycol n-butyl ether, tripropylene glycol n-butyl ether, propylene glycol phenyl ether, propylene glycol diacetate, dipropylene glycol dimethyl ether, an alcohol of the formula R₂—OH, where: R₂ is an alkyl group having 1 to 8 carbon atoms, a tetrahydrofurfuryl group, a benzyl group or hydrogen; an N-alkyl pyrollidone of the formula R₃Npyrr where Npyrr represents a pyrollidone ring and R₃ is an alkyl group having 1 to 8 carbon atoms, a dibasic ester of the formula R4-O—CO—(CH₂)ₖ—CO—O—R₄, where: R₄ is methyl, ethyl, or isobutyl and k is an integer from 2 to 4, and combinations thereof. The more than one liquid phase could include pH modifying components for the cleaning agent. The pH modifying components are alkanolamines and/or acids. The alkanolamines are chosen from monoethanolamines, diethanolamines, triethanolamines, aminomethylpropanol, methylethanolamine, methyldiethanolamine, dimethylethanolamine, diglycolamine, methylethanolamine, monomethylethylethanolamine, dimethylaminopropylamine, aminopropyldiethanolamine, isopropylhydroxylamine, dimethylamino methyl propanol, and mixtures thereof, and the acids are chosen from inorganic mineral acids and their salts, weak organic acids having a pKa of greater than 2 and their salts, ammonium salts, acetic acid, ammonium acetate, boric acid, and citric acid potassium biphthalate

There are several processes which cause the concentration of cleaning agent in the bath to change over time. The main mechanism that causes the concentration of cleaning agent to change is by evaporation of the bath or specific components in the bath. This is particularly an issue in a spray-in-air process where the small droplets, elevated temperature, and airflow promote evaporation. A general rule of thumb is the rate of the evaporation lost might be 2.5 to 8 gallons (about 9.46 to about 30.28 liters) per hour of operation although this is based on “typical estimations”. Different components in the bath will evaporate at different rates. For example, if the cleaning agent is primarily solvent based and the solvent evaporates faster than other bath components, over time the concentration of the cleaning agent will decrease, due to the fact that the solvent is the primary component of the bath, as the solvent is preferentially lost over water. Conversely if the bath contains high levels of certain other materials such as some types of surfactants, amines, or solid raw materials, all of which tend not to evaporate faster than water, then water may be preferentially lost resulting in an increase in concentration as the cleaning process proceeds. In short, evaporative losses, neglecting all other effects, will cause both a decrease in the volume of the bath and change in the concentration of all of the components of the bath, and not necessarily uniformly. The evaporative losses are a very complicated and dynamic system. The evaporation rate of the bath will depend on factors including but not limited to: the materials present, any azeotropes or azeotrope-like mixtures that form, the air flow rate through the machine, the environmental conditions (e.g. temperature, humidity, pressure). If there were two as identical as possible cleaning processes which are located in the same room, they will start out with identical cleaning agent concentrations but will have slightly different evaporative losses, and as such their concentrations will differ over time, which may cause one bath to fail before the other one. Due to the variability of the evaporation losses, it would be impractical to develop useful models on a case by case basis.

In addition to the above evaporative losses there are physical losses, also called drag out losses, where the bath, either as droplets in air or trapped in the parts being cleaned, is physically removed from the cleaning process in the liquid form. That is to say, ignoring any evaporative losses over time the volume of the bath will decrease. In processes where the bath is sprayed in air the droplets are carried by the ventilation or exhaust system out of the cleaning chamber. This loss can be, 1-5 gallons (about 3.79 to about 18.93 liters) of bath per hour of operation. This value is again a general value based on best estimates. The bath also gets physically removed from the cleaning process by entrapment on parts. All parts, immediately after contact with the bath ceases, will retain some of the bath. It may be retained in connectors, trapped under components, or be on the surface of the part. In inline cleaning processes the bath and cleaning agent in it will be physically moved into the next section, where it is lost. In batch systems it will not return to the tank holding the cleaning fluid, and will be instead rinsed on the part.

Soils introduce even more complexities to the composition of the bath and cause challenges in measuring the concentration of itself or the cleaning agent it is in. In the typical cleaning process, the soils are complex mixtures of chemicals and typically do not have a consistent composition, as opposed to a single chemical compound. For an illustrative example, solder flux is routinely cleaned in the type of processes the invention is designed for. Solder flux contains many raw materials, and many of these raw materials are mixtures with ill-defined compositions. For example, rosin, commonly found in solder flux, is derived from natural products, so each incoming lot of rosin will have differing chemical compositions. Furthermore, solder flux may contain polymers which are not a single molecule but are composed of different length molecules distributed around a certain length. More variations in the composition of flux arises when solder flux is reflowed. The reflow process causes numerous chemical reactions, which vary based on the conditions during reflow. This amounts to a solder flux that is not identical in composition from part to part. Solder flux was chosen as an illustrative example as it is well studied, however it does vary more than other soils in composition. However, most cleaning processes handle multiple types of parts, each of which may contain one or more different types of soils. The above discussion ignores other sources of variations in soil composition, such as the handling of parts during manufacturing. This leads to an ever changing composition of the incoming soil and one that is impossible to know.

As mentioned earlier, the method of the instant invention is based on using near infrared spectroscopy (NIRS) in a cleaning process to allow accurate measurements to be made of the cleaning agent concentration and/or soil in a bath for cleaning soils or contaminates from the products. This ensures the effectiveness of the cleaning process and lowers the cost of the process.

Near Infrared light (NIR) is generally defined as the light in the wavelength of 800-2500 nm, or 0.8-2.5 μm, or in the units most commonly used in NIR 12800-4000 cm⁻¹, Which is a shorter wavelength than the more commonly known Mid Infrared Range (MIR) of 2.5-25 μm. These cutoffs are typical values as there is no universal cut off. NIRS has many advantages over MIRS, as well as some disadvantages, for the application of this invention.

One appealing feature of NIR is its ability to be transmitted by fiber optics with acceptable losses, whereas MIR is not transmittable via fiber optic cables due to unacceptable losses in light intensity. This allows the light source, the bath, and the detector to be in physically different locations as long as they are connected via fiber optics. The fiber optic cables can be single fiber, which consists of one fiber that carries light, or multicore, which contains multiple fibers that carry light increasing the amount of light transmitted. This property also allows for the NIR spectrophotometer to be equipped with a multiplexer which allows for one spectrophotometer to make measurements from multiple cleaning process lines.

The unique features of a near infrared spectrum make it desirable to be used in this invention. As noted above the chemical composition varies over time so a method needs to be able to handle those changes. Spectrums in the MIR range will typically show organic functional groups, and complicated fine detail, albeit difficult to impossible for human interpretation that is specific to a chemical species. NIR spectrums typically show weak, broad bands that indicate functional groups that have a dipole, e.g., alcohols, large ethers, carboxylic acids, and amines, which are components of cleaning agents and soils. The broad bands in the near infrared spectrum are complex superpositions of individual components. Utilizing mathematical methods, specifically chemometric methods, one can deconvolute the peaks to provide the details required. As the changes are subtle in the near infrared spectrum, the method does not have to be able to handle the complexities of the complete appearance or disappearance of peaks of interest. This allows the method described in this invention to have enough selectivity to monitor concentrations of cleaning agent but not enough that the lot to lot variation in the cleaning agent composition inhibit quantifying the concentration. This also allows the present invention to measure the concentration of soils as the invention is not heavily dependent on the exact chemical composition of the soil like other spectroscopy methods, but more on the functional groups present, or the subtle effects that soil has on the abortion peak(s) of water or the cleaning agent. Another advantageous feature of NIRS vs MIRS is the absorption bands are weaker, which allows for easier quantification of substances. Quantitative MIRS analysis typically requires that the IR light pass through no more than 25-50 μm of the sample before it is too attenuated to be detectable. That is to say aqueous mixtures tend to be very opaque in the MIR region. The distance that the light travels through the sample (i.e. the distance light travels from the fiber optic that brings light to the sample to the fiber optic cable that takes it to the detector). This poses a problem in the analysis of heterogeneous samples as the IR light is not traversing through the bulk of the sample. In the NIR region the absorption bands are weaker, therefore, to get a spectrum that is within the limits of the detector's response, the light must travel through more of the sample to have enough absorption. Typically this distance is on the order of 1-3 mm which allows for the light to interact with a true representation of the total chemical composition. Selecting different path lengths in NIRS allows different features in the spectrum to be enhanced. For example lengthening the path length allows for minor components with weak absorbance peaks to be quantified although sacrifice of stronger peaks, as they may be large enough to saturate the detector causing them to not be used in the calibration model. Another advantage with NIRS is that the absorption spectrum consists of features caused by both the chemical and physical properties of the sample. There are numerous physical properties that can be correlated with NIR spectrum, where in the MIR range correlations are difficult to make. However, as discussed later the data processing and interpretation is more challenging in the NIR.

To implement the invention a near infrared spectrometer is needed. There are numerous types of NIR spectrophotometers available and numerous ways of introducing the NIR light to the sample to be measured. The main implementation of NIRS today uses Fourier transform near infrared spectroscopy (FT-NIR) instruments. The FT-NIR spectrometer has generally surpassed the other spectrometers. Examples of other spectrometers for the NIR region are: diode based NIR spectrophotometers, emitting diode array (EDA), diode array detectors (DAD), laser diodes; filter based spectrometers: fixed filter, wedge-interference filter (WIF), tilting spectrometers, acousto-optical tunable filter (AOTF) spectrometer, liquid crystal tunable filter (LCTF); prism based spectrometry; grading based spectrometers; and Hadamard based spectrometers, all of which may be used in the invention. The same characteristics that allow near infrared light to be transmitted via fiber optics allows for a multitude of ways to expose the samples to the near infrared light, which is beneficial in process control applications, as the probe design can be optimized.

The probe can be one of many different designs. The most common design is flow cells, through which the sample flows and light is directed through the sample on one side and exits the other. Reflectance probes are common and operate by allowing the light to exit the probe and reflect on the sample then to a detector. Reflectance probes do not look at transmitted light but reflected light which will have different spectral features than transmitted light. Additionally, there is single pass probes, which typically have a “C” shaped gap in them, through which the sample flows. On each end of the “C” there is an optical window interfaced with a fiber optic cable. The NIR light passes out one fiber/window, through the sample, and into the other window. The last common type, which is similar to the single pass probe, is the transflectance probe. The transflectance probe is very similar in design to the single pass probe, in the fact that it is “C” shaped and the sample flows in the gap. What separates this probe from single pass is, unlike single pass probes, which have fiber optics on both sides of the gap, the transflectance probe has both fibers on one side of the “C” and on the other side is a reflector. This results in the light entering the sample from one optical window, reflecting on the reflector and back through the sample and entering an optical window adjacent to the first one. The NIR spectrum of transflectance probes contains both a contribution from the transmission of the light and the reflection of the light. This is in direct contrast to the single pass probe which only contains transmission spectrum. There are other types of probe designs as well, but tend to be more specialized. In all cases the NIR light reaches a detector to produce the spectrum.

The detector converts the optical signal into an electrical signal which can be manipulated. To a large degree the detector dictates what wavelength(s) of light can be used in the invention. This is because the invention uses changes in light intensity and each detector only has a limited wavelength region in which its response is useful. While there are detectors that can cover the entire range of the NIR, they tend to be quite expensive and/or require cooling. There are numerous types of infrared detectors. The most commonly used types for NIR are: thermocouples, thermopiles, bolometers, pneumatic cell, pyroelectric detector, intrinsic semiconductors, and extrinsic semiconductors. The vast majority of detectors in use are semiconductors of the photoconductive or photovoltaic type. Some of the detectors must be cooled for proper operation or sensitivity which must be considered when selecting a detector. Some common cooling methods are chilled water recirculating loops, thermoelectric cooling, or the use of cryogenic materials (e.g. solid carbon dioxide, liquid nitrogen). Once the signal is processed it then can be viewed or manipulated as a spectrum.

As noted previously NIR spectrums tend to appear simpler than the MIR spectrum, which is misleading. The NIR spectrum contains a large quantity of data that overlaps and interacts. While the fundamental processes that lead to absorption peaks in NIRS produce broad absorption peaks, this effect is enhanced by the lack of selectivity in the NIR region. Typically an absorption peak in NIRS is the overlap of many absorption peaks from different chemical and physical processes that have very similar shapes but are usually offset slightly. These peaks are additive in the final spectrum yielding in broad peaks. Because the absorption peaks are similar slight changes in the shape or slight shifting of absorption peaks indicates changes in chemical composition and/or physical properties, which can be quite drastic. This typically necessitates mathematical operations to be applied to the NIR spectrum prior to developing or applying a quantitative model.

In order to develop a quantitative model using NIRS, raw NIR spectrums must be subjected to chemometric techniques. Typically the first step in the analysis of NIR spectrums is called “data pretreatment,” which consists of applying one or more mathematical operations to an individual spectrum or group of spectrums. Typically, due to fluctuations inherent in optical systems as well as in dynamic samples, several NIR spectrums are collected sequentially and then averaged together. This is an example of a simple data pretreatment. Other simple data pretreatments can include smoothing the data by one or more algorithms, taking one or more derivatives, applying mathematical operations to add, subtract, multiply, divide, etc. one or more spectrums from each other. There are also more advanced data pretreatment options for correcting for various spectral features. Once one or more of these data pretreatment options is applied to a spectrum, a modified spectrum is created. These modifications make developing a quantitative model slightly easier. Typically quantitative NIRS models require more advanced mathematical and statistical knowledge than other common quantitative spectroscopy techniques, such as ultraviolet-visible spectroscopy. This is due to the combination of physical and chemical information in the spectrum, which even after pretreatment creates complicated correlations between the variables in the process and the desired output from the model. In some instances using linear regression or multiple linear regressions and Beer's law is enough to create a calibration, but typically the relationships between variables require more robust techniques. Commonly employed analysis techniques include Partial Least Squares (PLS), Principle Component Analysis (PCA), and Factor Analysis (FA). There are limitless ways to develop a NIRS quantitative model that will give a response but in order for the invention to be useful it must be able to accurately predict the concentration of a sample not included in the calibration model development. To put it another way, the quantitative calibration model must not just fit one set of samples (or standards) but must be able to give a correct answer for any sample given to it.

The method of the instant invention should be able to be universally applied and replace prior methods in the field of aqueous cleaning processes. This invention pertains to a new method of monitoring and controlling the concentration of an aqueous cleaning agent and/or soils in a precision cleaning process, which has a high degree of accuracy. Its preferred use is in an in-line aqueous cleaner used to clean printed circuit boards (PCB) during and after manufacturing or assembly. It however, may be applied to any number of aqueous cleaning operations, such as those in the metal working, aerospace, optical, or semiconductor industries. The method may be implemented in a several different ways, such as a manual offline measurement method, or an automatic inline measurement method which provides near real time information. Further implementations extend this method to alert operators to cleaning agent and/or soil concentrations outside of a specified range or to automatically control metering systems to keep the cleaning agent concentration within said range. Another implementation would allow the method to stop the cleaning process and/or automatically drain the bath and replace it with virgin aqueous cleaning agent when the soil concentration reaches a particular value.

The method is based on near infrared spectroscopy (NIR). The preferred system for practicing the method comprises, at minimum, a near infrared spectrometer (NIRS), a NIR probe, fiber optics to connect the NIRS to the probe, software to control the NIRS, and software that processes the data from the NIRS (which may be part of the NIRS control software), and a calibration model which converts spectral features into a concentration measurement. Optional features of the preferred method comprise but are not limited to: settings for the computer to send signals to devices to automatically change the concentration of cleaning agent, alert operators when certain criteria are met, logging the concentration data to database for record keeping. As this method produces concentrations which essentially exist as data on a computer one skilled in electronics or computers may use the data in any number of ways.

In this method a suitable NIR probe is placed in contact with a sample of the bath. A suitable probe is defined as a probe type, examples include transflectance, flow cell, single pass probe, and other probes known to those skilled in the art, that will allow for the concentration of the cleaning agent and/or a component of the cleaning agent and/or water and/or soil to be determined using chemometric techniques, and is of such construction that the probe will be compatible with the conditions in and around the cleaning environment. The determination of a suitable probe is typically done in conjunction with the development of the calibration mode. One preferred configuration of probe type is transflectance probes, which produce spectrums that contain both reflectance and transmission components in them. It should be apparent that those skilled in the art may change the path length in the transmission style probes (such as flow cells or transflectance probes) to optimize the detection of critical components, which are components that if their concentration is allowed to change by more than a certain amount the cleaning process will be ineffective, inefficient, or fail, in the bath. An example of such an implementation would be to increase the path length to allow weaker absorbance peaks to be used for quantification. This typically will cause the absorbance peaks of water to saturate the detector and make using the water peaks a part of the calibration model difficult if not impossible. One skilled in the art will be able to examine different path lengths when they examine probe types and select an optimum path length and probe type by balancing all of the tradeoffs. The preferred method of contact of the bath with the probe is an inline manner allowing continuous monitoring of the bath with no physical operator intervention. An implementation of this would be to plumb the probe into a flowing stream, such as that from a pump or, or mounting the probe within the tank that contains the bath. Alternative methods of contact between the bath and the probe would be in an offline method where the sample of the bath is placed into a container, such as a beaker, and the probe is then placed into the container so that the optical path is through the bath sample.

The probe is connected using appropriate fiber optic cables to a NIR spectrometer. This allows the spectrometer to be located in a convenient location. The NIR spectrometer may be an “off the shelf” commercial NIR spectrometer or it may be custom built for this invention. The advantage of the custom built NIR spectrometer would be in situations where the calibration model determined that only certain discrete wavelength(s) or wavelength region(s) were needed to produce acceptable accuracy. Depending on the specific wavelength(s) or wavelength region(s) it may be more cost effective to have a spectrometer which only can measure those areas of the spectrum as opposed to the entire NIR spectrum. This may allow the use of less expensive optics or detectors. There are numerous types of NIR spectrometers commercially available. The preferred type would be a Fourier transform near infrared (FT-NIR) spectrometer or a diffraction based spectrometer. One skilled in the art will know the advantages and disadvantages of the types of NIR spectrometers and be able to select an appropriate one. The spectrometer serves to convert the optical signals into electrical signals which can be transmitted to a computer for processing and analysis. The computer may control the spectrometer and instruct it when to collect NIR spectrums, how often to take them, and to run internal tests and diagnostics.

In a preferred embodiment, the computer, which is connected to the spectrometer, is the main source of control of this method, as it controls the NIR spectrometer, receives data from the NIR spectrometer, processes the data, applies the calibration model to the processed data, displays and/or outputs by other means the concentration of the cleaning agent, parts of the cleaning agent, and/or soil. The data processing and quantification would be performed in software, detailed below. The computer may be a standard PC equipped with the correct hardware to interface with the spectrometer and software to implement the method or may be a programmable logic controller (PLC) programmed to process the data and produce outputs. It is important to note that the computer need not be a separate entity from the NIR spectrometer; it may be contained within it or as a component of it. Optionally this computer is equipped to control a series of valves and pumps. These valves and pumps allow for the computer to automatically add cleaning agent and/or water to the bath to adjust the concentration of the cleaning agent to be within a specified range or to stop the cleaning process and/or drain the tank when the soil concentration exceeds a certain value set by the operator. Optionally the computer may alert operators when certain conditions pertaining to the concentration of cleaning agent and/or soil occur. Another optional implementation of the computer would be the ability to interface with process logging systems to document the conditions of the cleaning process, or even to provide documentation about the cleaning process conditions when an individual part was cleaned.

The computer, be it a standard PC or a PLC, in the normal use of the method would have limited user interface and/or control of the software or the spectrometer. Some settings which may be allowed to be under user control are, but not limited to, setting the concentration measurement frequency (applicable to inline use only), selecting the cleaning agent used in the process, taking a single reading (regardless of any criteria for automatic measurements), select different calibration models to assess the accuracy, or to stop measurements. The computer would be able to display the concentration of cleaning agent and/or soil, typically in either weight percent or volume percent units.

The software that runs on the computer may be custom created or use one of the commercially available NIRS software. The software in normal operation would send signals to NIR spectrometer to collect one or more spectra. This can be done automatically or after an operator instructs it to. The software would then take the data from the spectrometer and apply any necessary data pretreatments before determining the concentration. During the development of the calibration model the necessary data pretreatments would be determined. Data pretreatments are well known in NIRS and are routinely used. In an advanced implementation of the invention, qualitative analysis algorithms could be used to select what data pretreatments are needed based on the observed spectrum and reference spectrum which include software instructions on the associated pretreatments to use. The advantage of that implementation is it would provide for a mechanism to have the system automatically select the best calibration model in the event that an interfering spectral component is seen. The chemometric methods to implement are well established.

The determinations of data pretreatments and calibration model to be used are best done by those skilled in the art of the cleaning agent formulation and cleaning processes. Using appropriate chemometric techniques and knowledge of the chemical composition of the cleaning agent, soils, and the range of the process parameters at which the cleaning agent is designed to operate, one can create an appropriate calibration model, which may include data pretreatments, for converting the optical data to a reliable concentration measurement. For ease in developing an implementation of the invention a typical laboratory NIR spectrometer may be used, as those systems tend to be designed for development of NIR methods. In doing so one many determine the requirements needed to implement the invention in an actual process. Examples of such requirements are probe type, optical path length spectral range(s) of interest, wavelength resolution, and data processing. However, in doing so the calibration model must be transferred to the final instrument which may entail modifications to the model. By creating a sufficiently comprehensive set of NIR spectra, which covers the expected full range of as many variables as possible, calibration models may be developed. Common calibration models include PLS, PCA, and SMLR but others may be more appropriate based on the variations in the observed spectra. By covering the breadth of variation in appropriate detail for the statistical model that is developed, the model will be robust, in the statistical sense, against variations in the process conditions. This ensures majority of the spectra of the bath samples will be accurately quantified by it.

In the development of these calibration models decisions must be made as to what to create the quantitative model for, as cleaning agents typically contain many components. In some cases using the appropriate chemometric analysis, one can create the calibration model which is based on the combined spectrum of all of the components in the cleaning agent. This initially will be the most accurate measure of concentration. However, as noted above it is possible over time that certain components concentrations may change. Glycol ethers which are commonly used in cleaning agents may volatilize in a cleaning process resulting in a changing concentration. Conversely, some materials, such as inorganic salts may accumulate over time as they will not evaporate. It may be advantageous to develop calibration models that measure a select few, or even just one, of the components in a cleaning agent and mathematically calculate the concentration of the cleaning agent based on the concentration of the measured component(s) in the formulation of the cleaning agent. In doing this, it can be ensured that any component of the cleaning agent that is critical to a successful cleaning process, is present and present in the correct amount. An alternate method may employ more than one calibration model and combine the results into an aggregated value, such as but not limited to an average, or give the range of the measured values.

To improve the utility of the method of the current invention one may also create calibration models for soils in the same manner. The preferred implementation of the invention quantifies the soil concentration as well. As the soils in a bath are not chemically well defined, due to the number of types of soil and the number of chemicals in soils the quantification of soil is a different challenge. There are numerous ways to overcome this in the present invention. One method is to identify, for each cleaning agent, the most common soils cleaned and prepare calibration model(s) for varying mixtures of soil at varying concentrations in the cleaning agent at various cleaning agent concentrations. There are limitations to this approach. The degree of variability in the nature of soil may make this approach impractical to impossible for any general model. It may however, be the most effective solution if a bespoke solution is required for a tightly controlled process in which the soils are consistent. To make this method more universal chemometrics may be employed to exploit various features of the system. One method that could be employed by one skilled in the art is to look for spectral features in various soils and calibrate based on general features in the spectra. The application of chemometrics allows for one skilled in the art to employ changes in spectral features, such as those of the cleaning agent or water to quantify the concentration of the soils. Another method would be to use PCA analysis for soils. Yet another method of implementation would be to create two models. One would be a calibration model for the cleaning agent and the other would be a calibration model for water. Once the concentration of those two components is measured one may use basic math to calculate soil, if one is willing to define soil as anything in the system that is not cleaning agent or water.

The method of the invention was implemented in an offline manual measurement manner. The implantation utilized a commercial FT-NIR spectrometer (Antaris II) equipped with an InGaAs photodiode and fiber optic connections. The spectrometer was connected to the probe using single core fiber optic cables with a nominal fiber diameter of 600 micrometers and of approximately 36 inches (about 91.44 cm.) of fiber. The probe was a standard DIP style transflectance probe with a fixed path length of 1 mm. The FT-NIR was connected to a standard PC computer running the data acquisition RESULT (Result Software Ltd.) and data processing software OMNIC™ (Thermo Scientific) purchased with the instrument. The probe was attached to standard laboratory supports so that it could be easily raised and lowered into a sample but at the same time remain in a fixed position while the data were collected. Below the probe was a standard laboratory hot plate with magnetic stirring (referred to as “hot plate”). To correct for optical imperfections of the system, a background spectrum of air was collected and subtracted from all spectra.

All samples were analyzed as identically as possible in order to minimize errors not inherent to the invention. To this effect, all samples were placed in identical jars, with identical stir bars, and the hot plate was set to the same revolutions per minute. This was to eliminate any effects that agitation had on the data. To facilitate the chemometric analysis of the invention, the actual temperature of the sample at the time of the measurement was measured by a resistive thermocouple device (RTD). This allowed for temperature effects to be accounted for. For the testing of the method a commercially available splitting aqueous cleaning agent was used (Aquanox A4625). Solutions of difference concentrations of cleaning agent were made using analytical balances. The concentration of the samples was measured using various methods in addition to the method of the invention. This section is broken up into the individual experiments conducted and then theoretical or future work.

### Example 1

### Initial Assessment

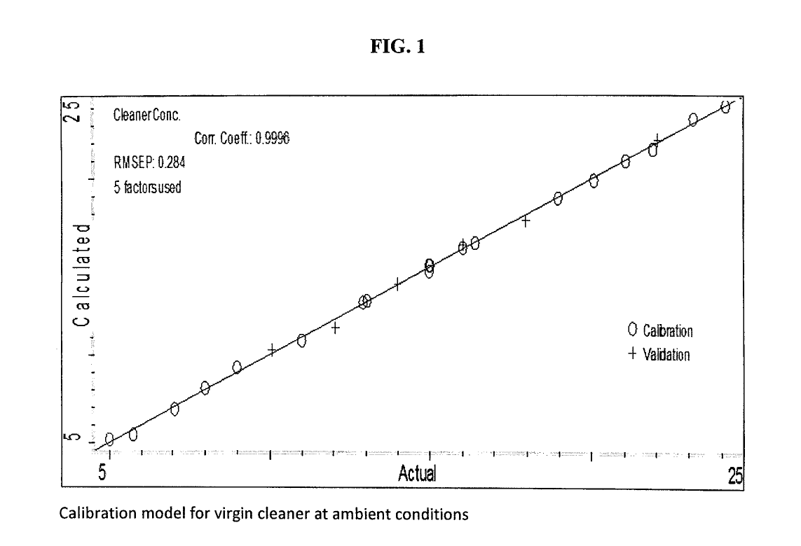

A calibration curve was constructed using the apparatus as described above, except without the RTD, and standards of known concentration. The cleaning agent standards were prepared gravimetrically by diluting concentrated cleaning agent with deionized (DI) water on an analytical balance with a resolution of 0.0001 g. The cleaning agent concentration spanned the concentration range of 5-25 wt. %, which is substantially wider than the typical concentration used in cleaning operations of 13-16%. All together 25 standards were used. Standards and samples were measured at ambient temperature, approximately. The FT-NIR scanned the range of wavelengths from 1.0-2.5 μm. As noted previously, an air background was subtracted from the spectra. Chemometric analysis was applied to determine what data pre-treatments, calibration model, and spectral regions produced acceptable results. The spectrum from approximately 2.0-2.12 μm was selected as it produced a calibration model that was based on spectral components from the entire cleaning composition. The data pretreatments used were: averaging 64 spectrum, taking the second derivative, and applying a standard data smoothing algorithm. The most suitable calibration model was a PLS model with 5 factors and had a correlation coefficient of 0.09996. Further validation was conducted on the model, again using standard chemometric methods. The expected standard deviation for unknown samples made using the model was 0.284%. The calibration model output is presented as FIG. 1.

Further chemometric analysis of the calibration model concluded that there were no statistically significant differences between the invention and a gravimetric technique that is accurate to 0.01%. No method currently used to control aqueous cleaning agents has that degree of accuracy.

### Example 2

### Creation of a Representative Calibration Model of the Invention

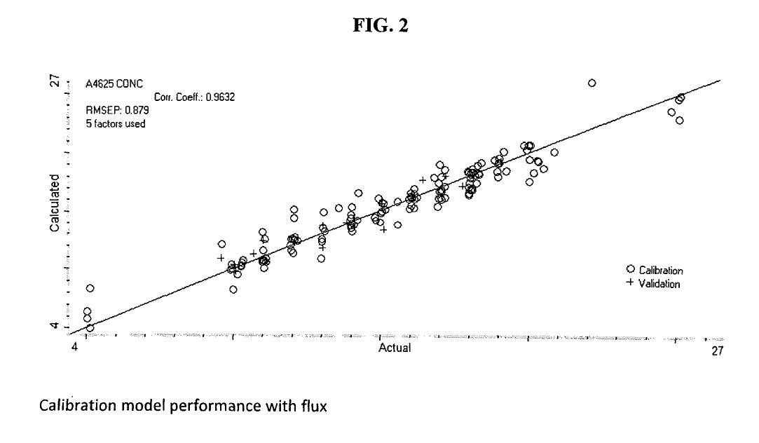

A more suitable implementation of the invention was desired. It is noted that soils in the bath are known to interfere with quantification of the cleaning agent. As a step towards the ideal implementation of the method, which is online and insensitive to soil, a calibration model incorporating interactions that soils have on the NIR spectrum of the bath was created. As the number of possible soils is limitless, a subset was selected. The subset consisted of solder fluxes of the rosin mildly activating type (RMA), no-clean, and water soluble types, which were reflowed to create the most realistic representation of the ideal implementation. These selected soils are representative of the soils the cleaning agent is used to remove. To further simulate the implementation of the method to an actual cleaning process the total concentration of soils in the bath spanned the range of 0.0-8.0 wt. %, well in excess of the 3 wt. % maximum soil load in most cleaning processes. As a further test of the utility of the invention the soils in each sample was a combination of the selected soils. The standards used in the model were again prepared gravimetrically on an analytical balance. The concentration of cleaning agent and the soil(s) in a sample were known to 0.01 wt. % which means that the invention cannot have accuracy better than that. A total of 150 standards were prepared and analyzed. Again standard chemometric techniques were employed to develop the calibration model. The most suitable calibration model was a PLS model with 5 factors and utilized ranges of wavelengths. The variations of temperature and soil loading were incorporated into the generated model. The temperature was maintained at 150±5° F. (about 65° C.). The calibration model was vetted using standard chemometric validation techniques. The resulting model had a correlation coefficient of 0.9632 and an error of 0.879%. The error is relative, meaning that for a bath containing cleaning agent at a concentration of 15% by weight, the expected range of values predicted by the model will be within 0.893% of 15% (i.e. between 14.87% and 15.13%). This is a substantial improvement over the published absolute errors of up to 3%. The calibration model output, with confidential information redacted is presented as FIG. 2.

### Example 3

### Comparison with Controls without Flux

The calibration model that was developed above, was compared to other methods for determining the virgin cleaning agent concentration in an off-line manual system. The methods it was compared with were methods based on refractive index, differential density, and sonic velocity, all of which are in current commercial use. The samples were virgin cleaning agent diluted to 13%, 15%, and 18% by weight in DI water. Five samples of sufficient quantity to produce samples for all methods, about 1.5 L, was prepared gravimetrically for each concentration. This resulted in fifteen samples (3 different concentration, 5 samples per concentration) to be analyzed by each method. The temperature of all samples were maintained at 150±5° F. (65° C.) while measurements were being made, to simulate process conditions.

The refractive index of the bath was measured using a handheld refractometer that had automatic temperature compensation. This is an important note as the bath sample rapidly cools when in intimate contact with the prisms. This negates the effect temperature variations have on this method. The refractive index calibration curve was based on virgin cleaning agent and simple linear regression. The differential density measurements were made by using a commercially available, but proprietary method. The differential density calibration curve was the calibration curve preconfigured within the device for the cleaning agent and was not modified in any way. The data for the calibration curve and the statistical data from the simple linear regression was determined using virgin cleaning agent. The sonic velocity measurements were made using a commercially available system. The calibration model was prepared and supplied by the manufacturer of the device. The methods used are reported to be proprietary but virgin cleaning agent samples were used and temperature dependent effects were included in the model.

Chemometric analysis was applied to the resulting concentration measurements to assess which method had better accuracy and precision. Due to non-normality of the data non-parametric methods were employed. The methods in determining this, and which specific statistical analysis is most appropriate is known to those skilled in the art. The accuracy was assessed using analysis of the median, instead of the mean, of the known concentration of the samples and the median of each concentration method. Precision was measured using appropriate nonparametric methods that looked at the variance. This invention was determined to be the most accurate and precise method, as the median was the closest to the true median and it had the smallest variance. The differential density and sonic velocity measurements had medians which were statistically the same as the invention and gravimetric methods, but those medians were further from the gravimetric median, and as a consequence the current invention. The variances of the current invention, the differential density, and the sonic velocity were statistically indistinguishable from the variance of the gravimetric method. However, once again the current invention had a smaller variance than the other methods. A table summarizing the results is presented as Table 1. The variance column is the variance of the difference between that test method and the gravimetric method.

TABLE 1
Summary of data with no flux

| Method | Median (wt. %) |
|---|---|
| Sonic Velocity | 15.720 |
| Gravimetric | 14.998 |
| NIR based | 14.937 |
| Refractive Index | 11.250 |

### Example 4

### Comparison with Controls with Flux

The experiment above was modified for testing the effect that soils have on the methods. The concentration of the cleaning agent was fixed at a nominal concentration of 15 wt. % to simplify data analysis. There were five fluxes selected as soils, the four from the development of the calibration model used in this invention, and one additional flux. The soil concentration ranged from 0-3% in order to give a fair assessment to all methods. The fluxes, serving as soils, were reflowed to reflect actual bath samples. The soils were all added gravimetrically to the cleaning agent. In addition the soils were only present individually in each sample, to allow for easy analysis of the impact of different types of soils. Again, as with the previous experiments the temperature was maintained to 150±5° F. (65° C.).

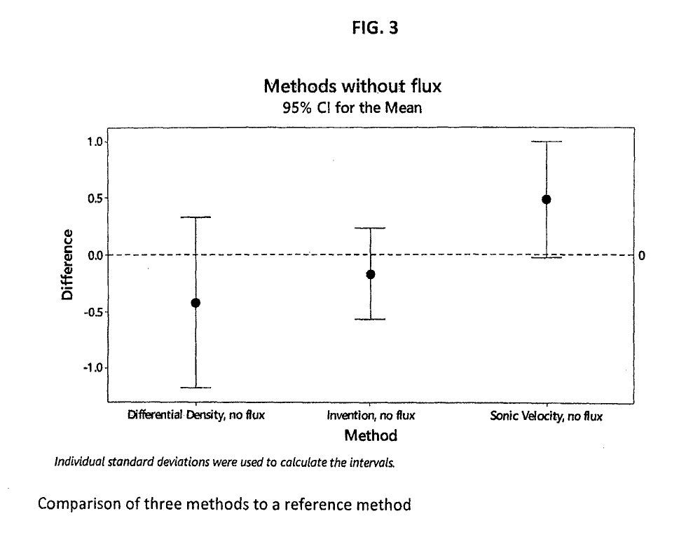

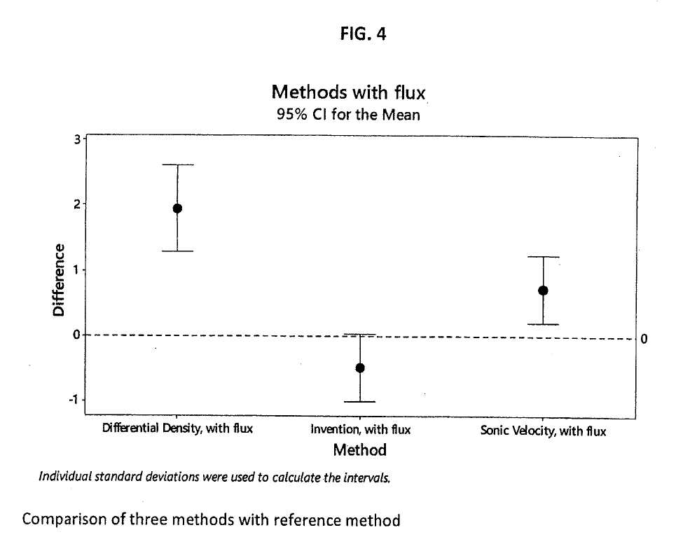

The refractive index of the samples was not measured due to its poor performance in the prior experiments. The calibrations used for the remaining methods: differential density, the invention, and sonic velocity were the same as in the previous experiment. FIG. 3 shows the interval plot for the difference between each method and the gravimetric reference method is shown to indicate the accuracy and precision of the methods. This is presented for reference when examining the data with flux. The corresponding graph for baths with soil is shown in FIG. 4, and is very similar to FIG. 3. The method of the invention is the most accurate and precise.

An embodiment of the invention may comprise a method of accurately measuring the concentration of at least one of an aqueous cleaning agent and soil in an aqueous cleaning bath comprising:

A. providing a source of near infrared light emitting useful amounts of light with wavelengths between approximately 0.8 μm and 2.5 μm,

B. transmitting said near infrared light from said light source to a probe,

C. contacting said probe with a cleaning bath sample such that one of the absorption and the reflection of the near infrared light at one or more wavelengths can be measured,

D. transmitting the near infrared light that has interacted with said sample to a detector,

E. measuring a change in light intensity at one or more wavelengths in the near infrared region using said near infrared detector,

F. generating an electronic signal that is representative of said change in light intensity, and

G. quantitatively determining the concentration of at least one of said cleaning agent and said soil by applying chemometric techniques to said electronic signal.

Another embodiment of the invention may comprise a method of accurately maintaining the concentration of at least one of an aqueous cleaning agent and soil in an aqueous cleaning bath comprising:

A. providing a source of near infrared light emitting useful amounts of light with wavelengths between approximately 0.8 μm and 2.5 μm,

B. transmitting said near infrared light from said light source to a probe,

C. contacting said probe with a cleaning bath sample such that one of the absorption and the reflection of the near infrared light at one or more wavelengths can be measured,

D. transmitting the near infrared light that has interacted with said sample to a detector,

E. measuring a change in light intensity at one or more wavelengths in the near infrared region using said near infrared detector,

F. generating an electronic signal that is representative of said change in light intensity,

G. quantitatively determining the concentration of at least one of said cleaning agent and said soil by applying chemometric techniques to said electronic signal, and

H. replenishing at least one of said cleaning agent and water to maintain the concentration of said cleaning agent within a user defined range.

Another embodiment of the invention may comprise a system for accurately measuring the concentration of at least one of an aqueous cleaning agent and soil in an aqueous cleaning bath comprising:

A. a source of near infrared light emitting useful amounts of light with wavelengths between approximately 0.8 μm and 2.5 μm,

B. a probe adapted to be disposed in contact with a cleaning bath sample such that one of the absorption and the reflection of the light at one or more wavelengths can be measured,

C. a fiber-optic cable connecting said near infrared light from said light source to said probe,

D. a near infrared detector that measures the change in light intensity at one or more wavelengths in the near infrared region and converts the change in light intensity into an electronic signal, and

E. a fiber-optic cable transmitting said near infrared light that has interacted with said sample to said detector.

### Methodology

The study was divided into two primary phases. The objective of Phase 1 was to evaluate each of four measurement technologies versus known concentrations of a popular multi-phase aqueous cleaning agent. Phase 2 then examined how varying flux loading across multiple flux categories (no-clean, rosin, water soluble) affected those readings.

### Phase 1—Dilutions of Virgin Cleaning Agent

Using an analytical laboratory balance, solutions of known concentration were carefully prepared gravimetrically. Five (5) samples were made at each: 13%, 15%, and 18% to cover the typical operating range for modern aqueous cleaners.

Because the solubility of multi-phase cleaning agents in the aqueous phase varies with temperature, each solution was heated to 150° F. (65° C.), the (upper limit of most cleaning processes) before taking any measurements. This was also important due to the temperature/density sensitivity of the instruments discussed previously. The samples were well agitated to ensure that all phases were thoroughly mixed. If a portion of any layer remained separated it could adversely affect the measurements.

### Statistical Discussion for Phase 1

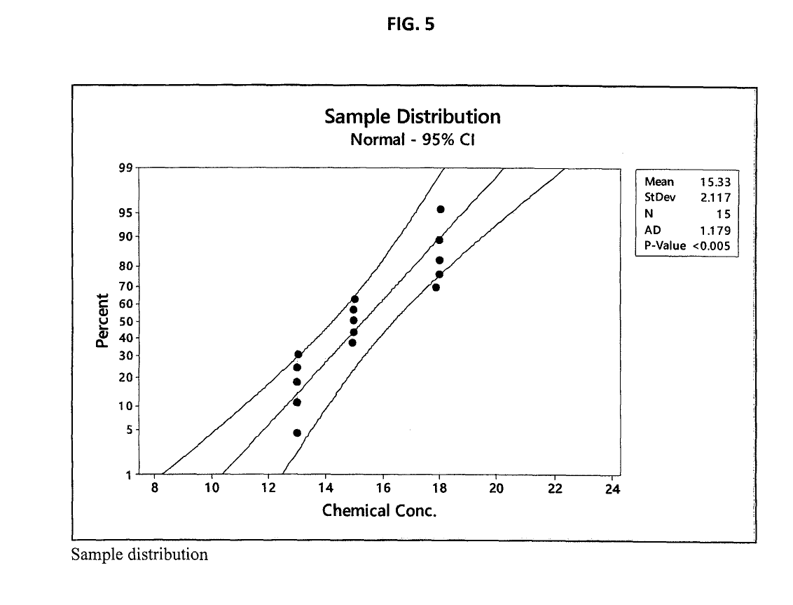

A 95% confidence interval (CI) was chosen to statistically analyze the data. The first step was to test for normality of the dataset. The sample distribution is shown in FIG. 5.

With a P-value of less than 0.05, the Design of Experiment did not follow a normal distribution curve, resulting in the use of non-parametric statistics.

The next step was to test for equal variances in the distribution of data between the gravimetrically known concentrations and the instrument readings. Levene's Test was selected due to the non-parametric data distribution. If the resulting P-value is less than 0.05 (95% CI) then the difference in variances is unlikely to have occurred as a result of random sampling of the population. Conversely, if the P-value is greater than 0.05 then the variances are statistically equivalent. Shown graphically in the following Figures, there must be at least partial overlap between the two ranges to have equivalent variances. If the intervals do not overlap, the corresponding variances and standard deviations are significantly different.

### Refractive Index Test (RI)

Levene's test P-value was 0.162. Although small, a portion of the ranges does overlap therefore the RI measurements have equal variance in this dataset.

The assumption holds for equal variance, but not for normality, the Mann-Whitney test was chosen to determine if there is a statistical correlation between the RI readings and the known gravimetric concentrations.

TABLE 2
Median data for Refractive Index

| | N (sample | |
|---|---|---|
| | size) | Median (%) |
| Gravimetric | 15 | 14.998 |
| Refractive | 15 | 11.250 |
| Index | | |

The Mann-Whitney test shows a significance of 0.0100 (adjusted for ties). This value is below 0.05 for the 95% CI, therefore the RI readings do not have a statistically significant correlation with the known concentrations of virgin chemistry. This was not unexpected due to the intrinsic challenges of measuring the refractive index of multi-phase cleaning agents.

### Sonic Velocity Test (SV)

Levene's test P-value was 0.846. There is equal variance between the known values and sonic velocity measurements as shown by the overlapping intervals

TABLE 3
Median data for Sonic Velocity

| | N (sample | |
|---|---|---|
| | size) | Median (%) |
| Gravimetric | 15 | 14.998 |
| Sonic Velocity | 15 | 15.720 |

The Mann-Whitney test shows a significance of 0.6186 (adjusted for ties). This value is above 0.05 for the 95% CI, therefore the sonic velocity measurements do have a statistically significant correlation with the known concentrations.

The Mann-Whitney test shows a significance of 0.6186 (adjusted for ties). This value is above 0.05 for the 95% CI, therefore the sonic velocity measurements do have a statistically significant correlation with the known concentrations.

### Differential Density Test (DD)

Levene's test P-value was 0.843. There is equal variance between the known values and differential density measurements as shown by the overlapping intervals.

TABLE 4
Median data for Differential Density

| | N (sample | |
|---|---|---|
| | size) | Median (%) |
| Gravimetric | 15 | 14.998 |
| Differential | 15 | 14.300 |
| Density | | |

The Mann-Whitney test shows a significance of 0.6186 (adjusted for ties). This value is above 0.05 for the 95% CI, therefore the differential density measurements do have a statistically significant correlation with the known concentrations.

While the Levene P-values and Mann-Whitney significance test results are essentially identical between sonic velocity and differential density measurements, this is not of statistically significance. Of greater interest was that the medians for sonic velocity and differential density were both offset from the known median by 0.7%. Sonic velocity was lower than the known while differential density was above.

### The Test of the Instant Invention

TABLE 5
Median Data for Inventive Method

| | N (sample | |
|---|---|---|
| | size) | Median (%) |
| Gravimetric | 15 | 14.998 |
| Inventive | 15 | 14.937 |
| Method | | |

The Mann-Whitney test shows a significance of 0.5069 (adjusted for ties). This value is above 0.05 for the 95% CI, therefore the measurements do have a statistically significant correlation with the known concentrations.

The median value for this method was the closest to the known solutions with a difference of 0.061%.

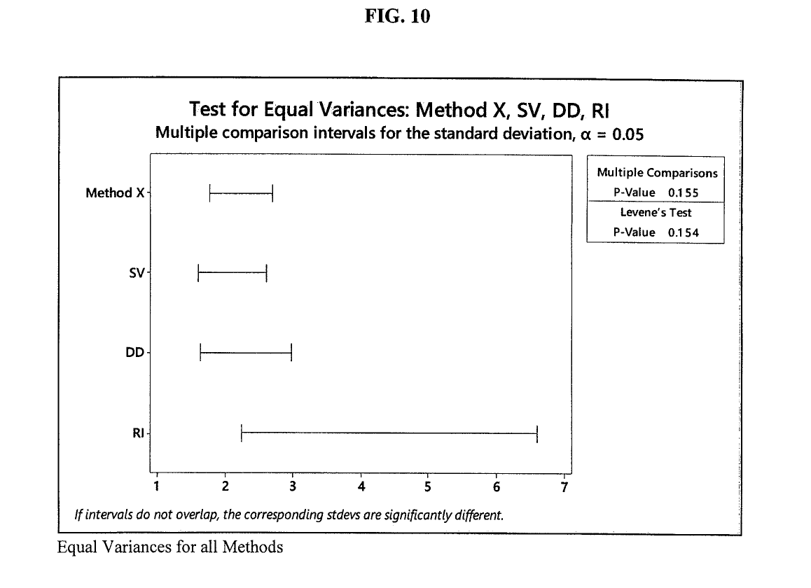

The intervals in FIG. 10 overlap therefore equal variance exists among all four methods. The methods were next compared against one another using the Kruskal-Wallis test. This is a non-parametric method for determining whether the samples originate from the same distribution. For parametric datasets, the equivalent test is one-way ANOVA. (analysis of variance).

TABLE 6
Kruskal-Wallis Dataset

| | Median | | |
|---|---|---|---|
| | (%) | Avg Rank | Z |
| RI | 11.25 | 19.2 | −2.89 |
| SV | 15.72 | 38.4 | 2.03 |
| DD | 14.30 | 32.7 | 0.29 |
| Inventive | 14.94 | 32.7 | 0.57 |
| Method | | | |

With a P value of 0.021, the Kruskal-Wallis test concluded that at a α-level of 0.05 the four methods vary significantly. The Avg Rank may indicate that RI is the method that is different from the other three.

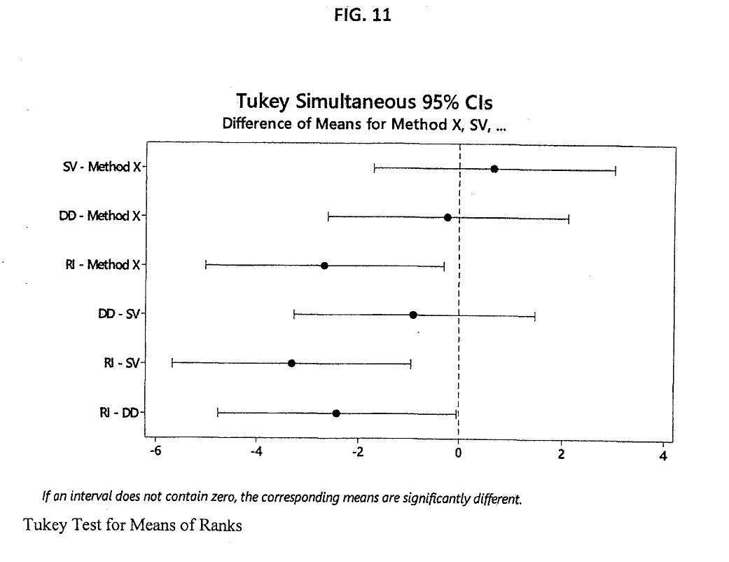

Applying Tukey's range test to the means, the possible pairings can be compared. Shown graphically, the test allows one to determine which mean(s) are significantly different from each other. If an interval pairing does not contain zero, the corresponding means are significantly different. In FIG. 11, the DD-RI pairing is very close to zero but doesn't cross it; therefore the means are significantly different.

The Tukey analysis shows that difference in Means from any pairing of sonic velocity, differential density, and the instant method are statistically insignificant. Conversely any pairing involving refractive index was significantly different. This, along with the Kruskal-Wallis ranks, confirms that RI is significantly different from the other three methods.

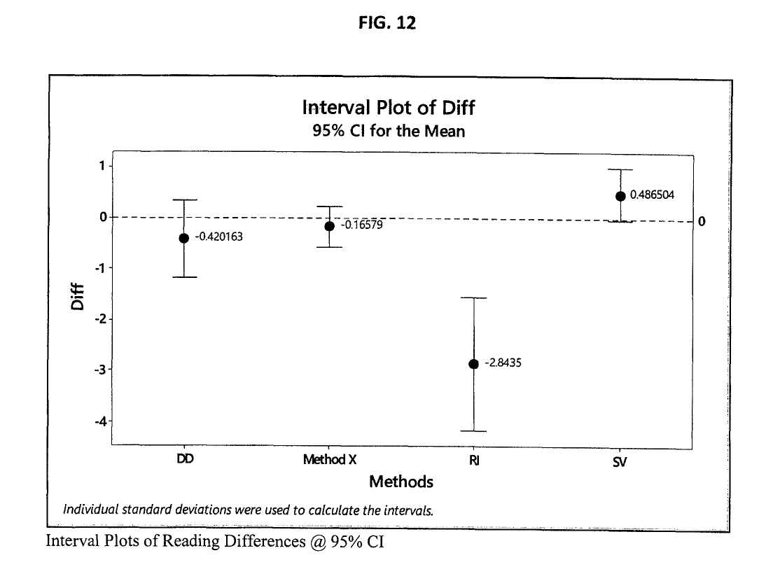

FIG. 12 graphically summarizes this portion of the study by showing the means and standard deviation intervals for each of the four methods The zero line represents the known concentration. For the intervals that cross zero, there is a 95% confidence that the measurement is significant.

While RI has been successfully used for decades with homogeneous aqueous cleaning agents, it is not an accurate method for measuring virgin solutions of multi-phase type cleaning agents. The other three methods all cross or touch the known concentration; therefore they have statistically significant correlations to known concentrations. Sonic velocity and differential density are approximately equal in accuracy. Sonic velocity tended to overvalue the concentration while differential density underestimated by a similar amount. The instant inventive method was the most accurate and had the tightest distribution.

### Phase 2—the Effects of Dissolved Flux Residue

The second portion of this study was to examine how varying soil load (dissolved flux) affected the concentration measurements. Because RI failed to have a significant correlation with virgin solvent splitting solutions, only the other three methods were evaluated in this section.

The concentration was fixed at 15% using the same multi-phase cleaning agent as in Phase 1. Samples were gravimetrically prepared in a consistent manner with Phase 1 using an analytical laboratory balance. Five diverse soldering materials were selected based on known acceptance in the industry.

TABLE 7
Flux Materials Studied

| Flux ID | Class | Type | Notes |
|---|---|---|---|
| 1 | Wave solder | No Clean | HF |
| 2 | Paste | Water | HF |
| | | Soluble | |
| 3 | Wave solder | Water | VOC- |
| | | Soluble | Free |
| 4 | Paste | No-Clean | HF |
| 5 | Wave Solder | Rosin | |

To accurately simulate the residues post-soldering that would be removed by the cleaning process, liquid fluxes were carefully boiled down to their solids content. For the solder pastes, the manufacturer graciously provided the flux vehicle without the alloy content. Small volumes of the flux were placed in aluminum trays and reflowed according to the recommended profile.

Using the standard gravimetric method, each soil was added to the known 15% concentration of the cleaning agent at concentrations of 1%, 2%, and 3% loading. This created a total of 15 distinct samples. As in Phase 1, the samples were heated to 150° F. (65° C.) and well agitated. Prior to taking any readings, the samples were visually inspected to ensure the entire mass of flux residue had solubilized.

Three percent soil on a mass basis equates to approximately 20 Lbs (9 kg) of dissolved material for a typical 80 gallon (300 Liter) wash tank.

Mann-Whitney tests were performed on each of the three sensor technologies to determine if there is a significant correlation with known concentrations when measuring the array of 15 flux loaded solutions. Using the 95% confidence index, the test result needs to be above 0.05 to show significance.

TABLE 8
Mann-Whitney Test Results for Flux

| | Test Value | Result |
|---|---|---|
| SV | 0.0014 | Not Significant |
| DD | 0.0000 | Not Significant |
| Inventive | 0.3615 | Significant |
| Method | | |

Only the inventive method showed to be significant. This was a surprising result based on years of successful field experience with the Differential Density sensor in process control applications.

Upon closer inspection of the data, Flux #1 (halogen free, no-clean, wave solder) created the most variation in all three techniques. Table 9 shows the delta between measured reading and the known control concentration. If soil had no affect the difference would be 0%.

TABLE 9
Reading Differences in (%) for Flux #1, Average of Combined Average
of Other Fluxes.

| Soil Load | Inventive Method | Sonic Vel. | Diff. Density |
|---|---|---|---|
| 1% | −0.84 | 1.02 | 1.64 |
| 2% | −1.56 | 1.43 | 4.46 |
| 3% | −2.21 | 3.36 | 4.8 |

Average of Other 4 Soils

| | | | |
|---|---|---|---|
| 1% | −0.54 | 0.46 | 1.19 |
| 2% | 0.08 | 0.35 | 1.63 |
| 3% | −0.09 | 0.31 | 1.60 |

Modern fluxes (liquid, pastes, tacky, etc.) are complex formulations engineered to provide specific soldering properties. While there is some commonality in the alloys used, every solder manufacturer uses its own proprietary blend of additives to achieve their desired fluxing characteristics. As a result, there are hundreds of distinct fluxes used in the marketplace today. Experience has shown that those minor differences lead to some materials being significantly more challenging or easier to clean. No two flux residues are the same. In much the same way, it is not surprising that some materials will interfere with the various concentration measurement technologies more than others.

While no technique is truly immune to the effects of soil loading, this small sampling suggests that large discrepancies in accuracy are possible due to the nature of a particular soil rather than the method itself. Likewise, the negative effect is not likely to have the same error factor for every measurement method. This is evidenced by Flux #1 having 10× the effect on sonic velocity measurements compared with the average of the other four fluxes at 3%. Differential density was also 3× higher for Flux #1 at 3% than the average.

In previously published work on acoustic based concentration measurements and loading with a particular RMA flux the author(s) stated, “the flux addition induced a maximum intrinsic error of 3% at a concentrated flux loading of 3%.” [U. Tosun, Zestron, “Concentration Monitoring & Closed Loop Control—A Technological Advancement”, SMTA International Proceedings, October 2013] That measurement was made using a different, privately labelled sonic velocity instrument. However if considering the sonic velocity technologies from multiple experienced OEM's to be approximately the same, then the RMA had an overall effect similar to Flux #1 which is a no-clean. This further supports the conclusion that measurement accuracy can be dramatically influenced by the composition of individual fluxes. Only the new method of the instant invention passed the Mann-Whitney test for the soil loaded samples, demonstrating it is the more robust technology.

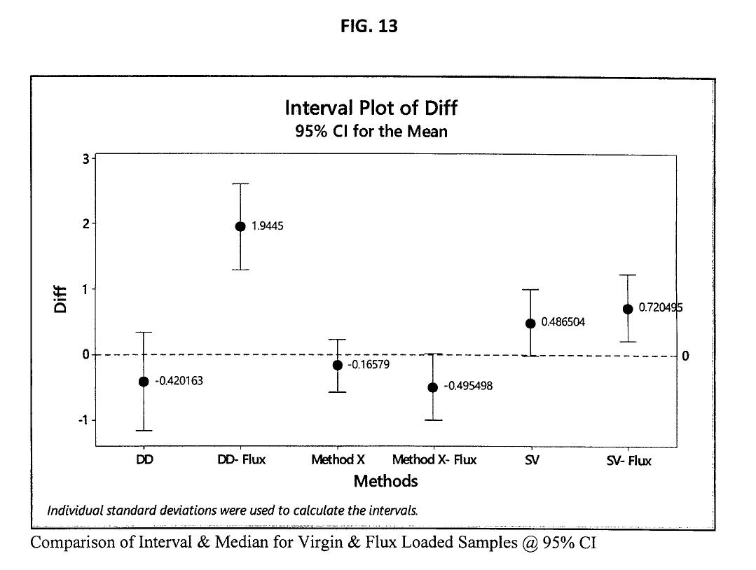

FIG. 13 compares the difference between the known concentration and measured values as obtained by the three instruments for both virgin and flux loaded samples. Data from all five fluxes is included.

Only the standard deviation interval for the inventive method crossed or touches the zero line for the flux loaded samples; representing a 95% confidence level that its reading is significant.

Note that soil load affected the accuracy of the readings, but had little impact on their precision (grouping). This is most clearly shown in the differential density readings where the interval shifted approximately 2% higher, but the spread of the interval itself remained almost unchanged. Similar trends are seen in the sonic velocity measurements.

### Monitoring Soil Load

Dissolved flux residues have long interfered with concentration measurement technologies applied to both homogeneous and multi-phase cleaning agents. This study has highlighted that not all flux residues are created equal, some will have more significant impact due to their composition. To produce reliable product with high first pass yields, today's cost-conscious assemblers demand robust and tightly controlled cleaning processes. Accurate control is difficult to achieve without knowing how the dissolved soil load is impacting the concentration reading. Many aqueous cleaning agents provide long bath life, often holding at least 3% flux residue in solution and sometimes much more before requiring replacement. If for example your cleaning specification has a tolerance of ±2% from the nominal target, a process removing high volumes of Flux #1 could unknowingly exceed that specification due to interferences with the actual concentration. Knowing the soil load can help compensate the measurements and in determining when the bath should be replaced.

A non-volatile residue (NVR) test is traditionally used to quantitatively measure how contaminated the wash bath is. This is not a difficult test, but it does require specific laboratory equipment and typically takes hours if not overnight. In many cases samples are therefore sent into the chemical vendor for analysis and a report is generated. Even with rapid turnaround times, the bath has continued to load by the time the test is completed.

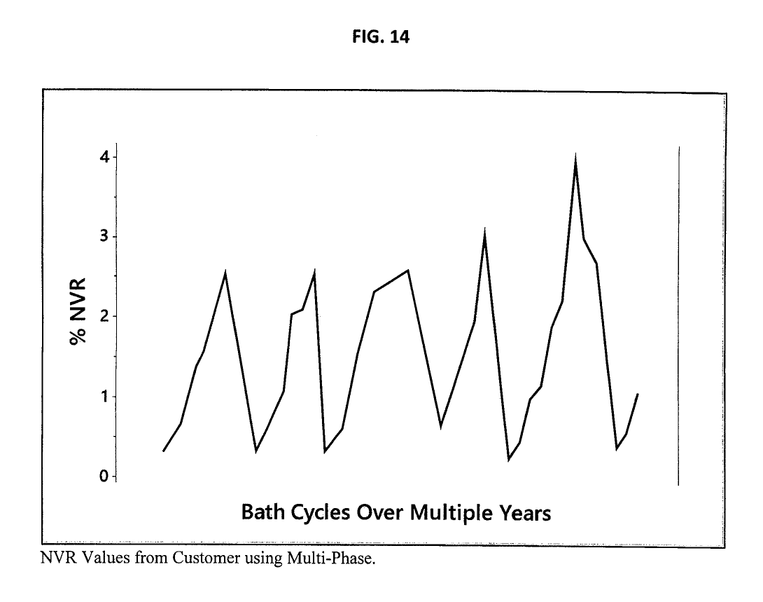

FIG. 14 shows the very cyclical pattern of soil loading from a customer using the multi-phase cleaning agent used in this study. They submitted systematic samples for NVR analysis to track the bath. The peaks and valleys indicate where the bath was replaced. While starting out conservatively, over time they extended bath life by accumulating higher soil loads without adversely affecting cleaning.

In-line washers are very dynamic processes, the specific rate at which flux residues accumulate in the wash bath is dependent on several factors including drag-out and stack losses. The tighter the machine is (less losses), the more rapidly soil load will increase. On a site-by-site basis, this behavior can be monitored in order to create a “Profile” for that unique process. By correlating soil load rate to wash pump operating time, a predictive model can approximate soil load at any given time during the life of the wash bath. Compensating concentration readings for soil load has long been a feature of some automated concentration control systems.

Knowing the soil load can not only increase the accuracy of concentration measurements, but it can also be a tool for gauging condition of the wash bath and remaining life. Other than predictive modeling, can quantitative measurements of soil load be made in real-time? We know that the following equation is true for concentration measurements which are correlated to a change in some physical property.

R_{chem}+Rₛₒᵢₗ=Rₜₒₜₐₗ

### Where:

R_{chem} is the portion of the reading due to chemistry,
Rₛₒᵢₗ is the soils interference with the reading, and
Rₜₒₜₐₗ is the reading as measured on a given instrument.

Without additional information, it is impossible distinguish between what part of the total reading is due to the cleaning agent and what is related to the soil. Bath contamination generally has a positive contribution, making the actual concentration lower than the value read. However that cannot be universally assumed as some soils have a negative contribution, making the true chemical concentration higher than measured.

Wash bath concentration cannot be accurately measured by conductivity analysis due to the ionic contribution from dissolved flux residues. This is true for both homogeneous and multi-phase cleaning agent types.

In general mathematics, one needs two equations to solve for two unknowns. Therefore it was hypothesized that conductivity could provide the second reference point. By measuring bath conductivity at the same time as concentration, could both concentration and soil load be solved for simultaneously. This was investigated by recording the conductivity of each flux loaded solution during Phase 2.

Three of the five flux types showed increasing conductivity with higher soil load. The other two flux types (#1, #2) have one point that makes them irregular. Even if those were due to a measurement issue, significant variation exists in the slope and magnitude of the conductivity value for the materials.

### Complete Process Control

All of the methods explored in these tests can be used to monitor a cleaning process. However, most assemblers desire more than simple monitoring. They demand control and better yet automated process control.

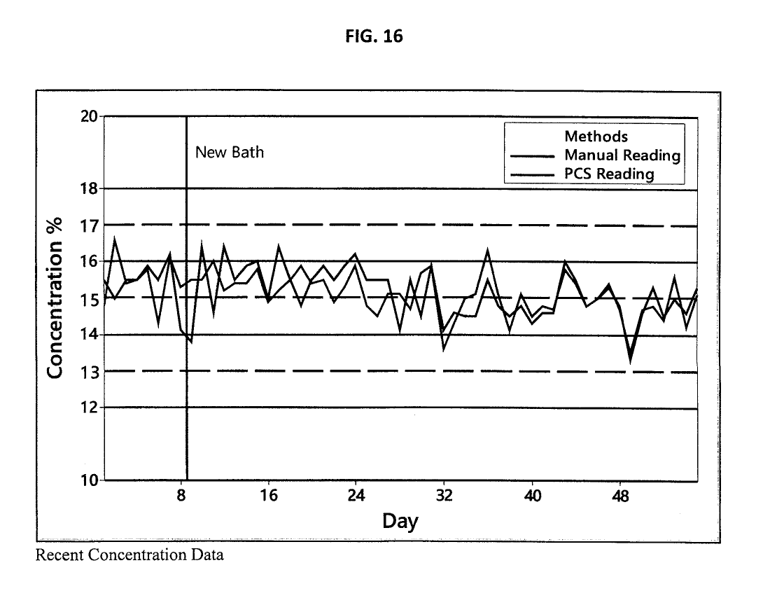

True automatic process control involves more than just reading the wash concentration, it requires the ability to respond to the dynamic changes which occur over the course of an operating shift. For almost a decade differential density technology has been successfully used in fully automatic control systems to maintain the concentration of multi-phase chemistries. FIG. 16 provides a comparison of logged manual versus process control system (PCS) readings (DD based) from a very high reliability application over several months earlier. The dashed line at 15% represents their target operating concentration of 15%, while the dashed lines at 13% and 17% indicate their upper and lower of control limits. Operators manually verify the concentration daily.

The dip in manual readings around the ninth sample point was associated with a bath change out. The automated control system used differential density to precisely maintain the concentration of the multi-phase cleaning agent within 1% of the target setpoint essentially the entire time. Operators did not need to make any manual additions, limiting exposure and the chance of spills.

By logging and saving a digital record of chemical and water additions as well as monitoring hours of operation, advanced controllers can provide real-time trends on chemical and water consumption rates.

The dip in manual readings around the ninth sample point was associated with a bath change out. The automated control system used differential density to precisely maintain the concentration of the multi-phase cleaning agent within 1% of the target set point essentially the entire time. Operators did not need to make any manual additions, limiting exposure and the chance of spills.

By logging and saving a digital record of chemical and water additions as well as monitoring hours of operation, advanced controllers can provide real-time trends on chemical and water consumption rates.

On average, the wash process consumed 0.4 gallons (1.5 liters) of fresh cleaning agent per hour of operation. The wash tank required DI water make-up at a significantly faster rate and showed variation due to its higher volatility; averaging 4.5 gal (17 liters)/hr. The controller used overall chemical make-up ratio of just below 9% to maintain target operating concentration of 15%.

Mechanical issues or configuration changes within the washer can often lead to a step change in chemical and/or water consumption. A few common examples are misdirected spray bars, ventilation issues, and valve leaks or mis-positions. By configuring threshold values for any trended parameters, leading process monitoring and control systems are able to assist engineers and operators with early detection of such events before they escalate. Remote notifications, such as email alerts, are possible if capable devices are interfaced with the customer's internal network.

Manufacturers rely on precise control and monitoring of the wash bath concentration for an accurate process window and confidence in their product quality. These tests compared four distinct concentration measurement technologies as they apply to aqueous cleaning agents that formulated to have a multi-phase:
refractive index,
sonic velocity,
differential density, and
the inventive method.

Through non-parabolic statistical analysis, three of the technologies have a strong correlation with chemical concentration. As suspected, and now statistically demonstrated, refractive index is not a reliable measurement of multi-phase cleaning agents. However, it is for homogeneous cleaning agents.

Phase 2 showed that soil loading does affect each of the methods to unpredictable degrees, and that each flux affected the measurement devices differently. As demonstrated by Flux #1, certain materials can have a large impact on measurement accuracy regardless of the technology used.

Routine analysis has shown that soil often behaves in a cyclical pattern from one bath to the next for a given application. Therefore by creating a “bath profile” and monitoring hours of operation the soil load and its impact on the concentration reading can be predictable. This method has been successfully applied to concentration readings for both homogeneous and multi-phase cleaning agents where applicable for two decades.

Simply measuring the concentration is analogous to reading a gauge. True process control starts with accurate concentration readings (monitoring), but also involves control:
compensating for soil load where necessary,
automatically making precise chemical and water additions,
logging critical system parameters,
notifying process owners of trends and alarms.

The present invention has a wide range of methods of implementation, and not all have been explored. The data have sufficiently proven that the core measurement technique of the invention, NIRS, can be used to measure the concentration of aqueous cleaning agent in simulated baths that these additional implementations are expected to be very straightforward. The discussion of implementations of the invention that have not been tested will start out with slight modifications and then expand in scope. A discussion of the expected results will be included for each.

One skilled in the art could expand the calibration model with additional fluxes as well as bath samples from current users of the cleaning agent. The collection of the data would consist of replicating the data collection done when creating the calibration model, and pooling all available spectrum together and reanalyzing the data set. The data collection would require a large number of samples to be run, which would just be labor intensive. It is expected that different spectral region(s), data pre-treatments, and additional variables would be incorporated and accounted for. As the number of samples in the model increase, it is still anticipated PLS will work, as it is very robust model for NIR data, although examining other chemometric models would be prudent.

Preferably along with the expansion of the calibration model, the instrument may be configured to automatically collect spectrum either continuously or at regular intervals. Furthermore, the quantification of this data would occur in real time as well. This change to the current experimental set up is trivial to implement. The commercial spectrometer software has these features built in, so it is a matter of altering the control program to use that option. It would be at this step the functionality of the software may be configured to limit the operator's ability to change settings without a password. Again, this feature is already in the existing software, it is a matter of modifying the program. This is not expected to change the accuracy of the invention, rather it is to make it easier for the operator to collect the data.

The next modification to the current physical implementation of the invention would be to place the probe in an in-line configuration. Again, this is a trivial matter, as standard plumbing connections can form fluid tight seals with the probe. This allows the probe to be plumbed into the cleaning equipment using standard techniques. Once again, this would not fundamentally alter the method in any way. The probe that is used in these experiments is expected to withstand the environment within and around the cleaning equipment. If this expectation is not met other transflectance probes can be selected which are more suitable. These other probes have sapphire windows, higher quality stainless steel, and pressure ratings to 3,000 psi, and would be functionally equivalent to the current probe. After that implementation the only modification to the invention to achieve a preferred realization would be to integrate all of the above modifications into one user friendly unit.

To achieve a preferred implementation of the invention the computer would have to be able to interface with equipment to automatically adjust the cleaning agent concentration, log data, or other desired operations. Once again, this is easy to implement. Depending on the particular equipment and the communication protocols involved, this can be implemented with the existing equipment and software. The software is capable of exporting the data to process control servers as well as other programs and controllers. In the event of technical difficulties implementing this, a different spectrometer may be used. There are FT-NIR spectrometers which are designed specifically to be used in process control. The difference in these devices is that they are designed to output signals in formats, such as analog, that are universal in the process control world.

What is claimed is:

1. A method of accurately measuring the concentration of at least one of an aqueous cleaning agent and soil in an aqueous cleaning bath comprising:
A. providing a source of near infrared light emitting useful amounts of light with wavelengths between approximately 0.8 μm and 2.5 μm,
B. transmitting said near infrared light from said light source to a probe,
C. contacting said probe with a cleaning bath sample such that one of the absorption and the reflection of the near infrared light at one or more wavelengths can be measured,
D. transmitting the near infrared light that has interacted with said sample to a detector,
E. measuring a change in light intensity at one or more wavelengths in the near infrared region using said near infrared detector,
F. generating an electronic signal that is representative of said change in light intensity, and
G. quantitatively determining the concentration of at least one of said cleaning agent and said soil by applying chemometric techniques to said electronic signal.

2. The method of claim 1, wherein said near infrared light from said light source is transmitted to said probe through a fiber optic cable.

3. The method of claim 2, wherein said fiber optic cable comprises a single fiber.

4. The method of claim 2 wherein said fiber-optic cable is a multicore cable.

5. The method of claim 1, wherein said near infrared light that has interacted with said sample is transmitted to said detector through a fiber optic cable.

6. The method of claim 5, wherein said fiber optic cable comprises a single fiber.

7. The method of claim 5 wherein said fiber-optic cable is a multicore cable.

8. The method of claim 1, wherein said near infrared light source is an incandescent light source.

9. The method of claim 1, wherein said near infrared light source is a light emitting diode.

10. The method of claim 1, wherein said probe is of the transflectance, flow cell, or a single pass probe type.

11. The method of claim 10, wherein said probe is compatible with the cleaning agent, soil, and the temperature and pressure process parameters, to thereby reduce wear.

12. The method of claim 1, wherein said probe is in contact with said cleaning bath sample in an inline manner such that said probe is in continuous contact with a portion of said cleaning bath that is representative of the composition of said cleaning bath.

13. The method of claim 1, wherein said detector is a semiconductor detector of the photoconductive or photovoltaic type.

14. The method of claim 1, wherein said chemometric technique includes application of at least one data pre-treatment.

15. The method of claim 14 wherein said data pre-treatment is chosen from averaging multiple spectrum, taking derivatives of the data, subtracting a reference spectrum from the spectrum, applications of smoothing algorithms, and correction of various spectral features prior to quantitatively determining the concentration of at least one of said cleaning agent and soil.

16. The method of claim 15, where said quantitatively determining the concentration of said at least one of said cleaning agent and soil by the chemometric technique is performed by a calibration model using simple linear regression, partial least squares, and principle component analytics methods to provide suitable accuracy for controlling the cleaning process.

17. The method of claim 16, where said calibration model accounts for variations in the cleaning process due to at least one of soil, temperature variations, flow rate, and agitation.

18. The method of claim 16, wherein said cleaning agent or soil concentration is quantified using partial least squares

19. The method of claim 16, wherein said calibration model is based on the entire near infrared spectrum of at least one of the cleaning agent and soil.

20. The method of claim 16, wherein said calibration model is based on the spectral features associated with one or more of the components of the cleaning agent and soil.

21. The method of claim 1, wherein said quantitatively determined concentration of said at least one of said cleaning agent and soil is transmitted to a PCS system operatively connected to valves and pumps to thereby add at least one of water and cleaning agent to automatically keep the concentration of the cleaning agent within a user defined range.

22. The method of claim 1, wherein one near infrared light source and detector are enabled to interface with more than one probes simultaneously.

23. The method of claim 1, wherein said source of near infrared light is a near infrared spectrometer.

24. The method of claim 1, which is performed automatically and in real time when the cleaning process is in operation.

25. The method of claim 1, wherein said aqueous cleaning process removes solder flux residues and other contamination from electronics during manufacturing.

26. The method of claim 1, wherein said aqueous cleaning process removes solder flux residues and other contamination from electronics after manufacturing.

27. The method of claim 1, wherein said cleaning bath comprises more than one liquid phase.

28. The method of claim 27, wherein said more than one liquid phase comprises an aqueous phase and a solvent rich phase.

29. The method of claim 28, wherein said solvent rich phase comprises a solvent chosen from: propylene oxide based glycol ethers: propylene glycol methyl ether, dipropylene glycol methyl ether, tripropylene glycol methyl ether, propylene glycol methyl ether acetate, dipropylene glycol methyl ether acetate, propylene glycol n-propyl ether, dipropylene glycol n-propyl ether, propylene glycol n-butyl ether, dipropylene glycol n-butyl ether, tripropylene glycol n-butyl ether, propylene glycol phenyl ether, propylene glycol diacetate, dipropylene glycol dimethyl ether, an alcohol of the formula R₂—OH, where: R₂ is an alkyl group having 1 to 8 carbon atoms, a tetrahydrofurfuryl group, a benzyl group or hydrogen; an N-alkyl pyrollidone of the formula R₃Npyrr where Npyrr represents a pyrollidone ring and R₃ is an alkyl group having 1 to 8 carbon atoms, a dibasic ester of the formula R4-O—CO—(CH₂)ₖ—CO—O—R₄, where: R₄ is methyl, ethyl, or isobutyl and k is an integer from 2 to 4, and combinations thereof.

30. The method of claim 29, wherein said alcohol of the formula R₂—OH, where: R₂ is a tetrahydrofurfuryl group is tetrahydrofurfuryl alcohol.

31. The method of claim 28, wherein said more than one liquid phase includes at least one pH modifying component for the cleaning agent.

32. The method of claim 31, wherein said at least one pH modifying component is at least one of alkanolamines and acids.

33. The method of claim 32, wherein said alkanolamines are chosen from monoethanolamines, diethanolamines, triethanolamines, aminomethylpropanol, methylethanolamine, methyldiethanolamine, dimethylethanolamine, diglycolamine, methylethanolamine, monomethylethylethanolamine, dimethylaminopropylamine, aminopropyldiethanolamine, isopropylhydroxylamine, dimethylamino methyl propanol, and mixtures thereof, and said acids are chosen from inorganic mineral acids and their salts, weak organic acids having a pKa of greater than 2 and their salts, ammonium salts, acetic acid, ammonium acetate, boric acid, and citric acid potassium biphthalate.

34. A method of accurately maintaining the concentration of at least one of an aqueous cleaning agent and soil in an aqueous cleaning bath comprising:
A. providing a source of near infrared light emitting useful amounts of light with wavelengths between approximately 0.8 μm and 2.5 μm,
B. transmitting said near infrared light from said light source to a probe,
C. contacting said probe with a cleaning bath sample such that one of the absorption and the reflection of the near infrared light at one or more wavelengths can be measured,
D. transmitting the near infrared light that has interacted with said sample to a detector,
E. measuring a change in light intensity at one or more wavelengths in the near infrared region using said near infrared detector,
F. generating an electronic signal that is representative of said change in light intensity,
G. quantitatively determining the concentration of at least one of said cleaning agent and said soil by applying chemometric techniques to said electronic signal, and
H. replenishing at least one of said cleaning agent and water to maintain the concentration of said cleaning agent within a user defined range.

35. The method of claim 34, wherein said near infrared light from said light source is transmitted to said probe through a fiber optic cable.

36. The method of claim 35, wherein said fiber optic cable comprises a single fiber.

37. The method of claim 35 wherein said fiber-optic cable is a multicore cable.

38. The method of claim 34, wherein said near infrared light that has interacted with said sample is transmitted to said detector through a fiber optic cable.

39. The method of claim 38, wherein said fiber optic cable comprises a single fiber.

40. The method of claim 38 wherein said fiber-optic cable is a multicore cable.

41. The method of claim 34, wherein said near infrared light source is an incandescent light source.

42. The method of claim 34, wherein said near infrared light source is a light emitting diode.

43. The method of claim 34, wherein said probe is of the transflectance, flow cell, or a single pass probe type.

44. The method of claim 43, wherein said probe is compatible with the cleaning agent, soil, and the temperature and pressure process parameters, to thereby reduce wear.

45. The method of claim 34, wherein said probe is in contact with said cleaning bath sample in an inline manner such that said probe is in continuous contact with a portion of said cleaning bath that is representative of the composition of said cleaning bath.

46. The method of claim 34, wherein said detector is a semiconductor detector of the photoconductive or photovoltaic type.

47. The method of claim 34, wherein said chemometric technique includes application of at least one data pre-treatment.

48. The method of claim 47, wherein said data pre-treatment is chosen from averaging multiple spectrum, taking derivatives of the data, subtracting a reference spectrum from the spectrum, applications of smoothing algorithms, and correction of various spectral features prior to quantitatively determining the concentration of at least one of said cleaning agent and soil.

49. The method of claim 47, where said quantitatively determining the concentration of said at least one of said cleaning agent and soil by the chemometric technique is performed by a calibration model using simple linear regression, partial least squares, and principle component analytics methods to provide suitable accuracy for controlling the cleaning process.

50. The method of claim 49, where said calibration model accounts for variations in the cleaning process due to at least one of soil, temperature variations, flow rate, and agitation.

51. The method of claim 47, wherein said cleaning agent or soil concentration is quantified using partial least squares.

52. The method of claim 49, wherein said calibration model is based on the entire near infrared spectrum of at least one of the cleaning agent and soil.

53. The method of claim 49, wherein said calibration model is based on the spectral features associated with one or more of the components of the cleaning agent and soil.

54. The method of claim 34, wherein one near infrared light source and detector are enabled to interface with more than one probes simultaneously.

55. The method of claim 34, wherein said source of near infrared light is a near infrared spectrometer.

56. The method of claim 34, which is performed automatically and in real time when the cleaning process is in operation.

57. The method of claim 34, wherein said aqueous cleaning process removes solder flux residues and other contamination from electronics during manufacturing.

58. The method of claim 34, wherein said aqueous cleaning process removes solder flux residues and other contamination from electronics after manufacturing.

59. The method of claim 34, wherein said cleaning bath comprises more than one liquid phase.

60. The method of claim 59, wherein said more than one liquid phase comprises an aqueous phase and a solvent rich phase.

61. The method of claim 60, wherein said solvent rich phase comprises a solvent chosen from: propylene oxide based glycol ethers: propylene glycol methyl ether, dipropylene glycol methyl ether, tripropylene glycol methyl ether, propylene glycol methyl ether acetate, dipropylene glycol methyl ether acetate, propylene glycol n-propyl ether, dipropylene glycol n-propyl ether, propylene glycol n-butyl ether, dipropylene glycol n-butyl ether, tripropylene glycol n-butyl ether, propylene glycol phenyl ether, propylene glycol diacetate, dipropylene glycol dimethyl ether, an alcohol of the formula R₂—OH, where: R₂ is an alkyl group having 1 to 8 carbon atoms, a tetrahydrofurfuryl group, a benzyl group or hydrogen; an N-alkyl pyrollidone of the formula R₃Npyrr where Npyrr represents a pyrollidone ring and R₃ is an alkyl group having 1 to 8 carbon atoms, a dibasic ester of the formula R4-O—CO—(CH₂)ₖ—CO—O—R₄, where: R₄ is methyl, ethyl, or isobutyl and k is an integer from 2 to 4, and combinations thereof.

62. The method of claim 61, wherein said alcohol of the formula R₂—OH, where: R₂ is a tetrahydrofurfuryl group is tetrahydrofurfuryl alcohol.

63. The method of claim 60, wherein said more than one liquid phase includes at least one pH modifying component for the cleaning agent.

64. The method of claim 63, wherein said at least one pH modifying component is at least one of alkanolamines and acids.

65. The method of claim 64, wherein said alkanolamines are chosen from monoethanolamines, diethanolamines, triethanolamines, aminomethylpropanol, methylethanolamine, methyldiethanolamine, dimethylethanolamine, diglycolamine, methylethanolamine, monomethylethylethanolamine, dimethylaminopropylamine, aminopropyldiethanolamine, isopropylhydroxylamine, dimethylamino methyl propanol, and mixtures thereof, and said acids are chosen from inorganic mineral acids and their salts, weak organic acids having a pKa of greater than 2 and their salts, ammonium salts, acetic acid, ammonium acetate, boric acid, and citric acid potassium biphthalate.

66. A system for accurately measuring the concentration of at least one of an aqueous cleaning agent and soil in an aqueous cleaning bath comprising:
A. a source of near infrared light emitting useful amounts of light with wavelengths between approximately 0.8 μm and 2.5 μm,
B. a probe adapted to be disposed in contact with a cleaning bath sample such that one of the absorption and the reflection of the light at one or more wavelengths can be measured,
C. a fiber-optic cable connecting said near infrared light from said light source to said probe,
D. a near infrared detector that measures the change in light intensity at one or more wavelengths in the near infrared region and converts the change in light intensity into an electronic signal, and
E. a fiber-optic cable transmitting said near infrared light that has interacted with said sample to said detector.

67. The system of claim 66, wherein said fiber-optic cable connecting said near infrared light from said light source to the probe comprises a single fiber.

68. The system of claim 66, wherein said fiber-optic cable connecting said near infrared light from said light source to said probe is a multicore cable.

69. The system of claim 66, wherein said fiber-optic cable transmitting said light that has interacted with said sample to said detector comprises a single fiber.

70. The system of claim 66, wherein said fiber-optic cable transmitting said light that has interacted with said sample to said detector is a multicore cable.

71. The system of claim 66, wherein said near infrared light source is an incandescent light source.

72. The system of claim 66, wherein said near infrared light source is a light emitting diode.

73. The system of claim 66, wherein said probe is of the transflectance, flow cell, or a single pass probe type.

74. The system of claim 73, wherein said probe is compatible with the cleaning agent, soil, and the temperature and pressure process parameters, to thereby reduce wear.
